(19) United States
(12) Patent Application Publication
(10) Pub. No.: US 2026/0000245 A1
(43) Pub. Date: Jan. 1, 2026

(54) STAND MIXER BOWL COUPLING ASSEMBLY

(71) Applicant: Haier US Appliance Solutions, Inc., Wilmington, DE (US)

(72) Inventors: Danister Abeygunawardana, Jeffersonville, IN (US); Tomas Garces, Louisville, KY (US)

(21) Appl. No.: 18/756,767

(22) Filed: Jun. 27, 2024

(51) Int. Cl. A47J 43/07; A47J 43/044

(52) U.S. Cl. CPC A47J 43/0727; A47J 43/0711; A47J 2043/04454

(57) ABSTRACT

A stand mixer includes a base defining a cavity surrounded by a cavity wall, a support column coupled to the base and extending upwardly from the base, a head coupled to an upper end of the column and extending from the column above the base, and a bowl removably coupled to the base. The bowl includes a reservoir for holding ingredients and a bowl base defining a perimeter. The bowl base is insertable within the cavity. Additionally, the mixer includes a bowl coupling assembly for removably coupling the bowl to the base. The coupling assembly includes a tab including a sloped feature upon which the bowl is tiltable to remove the bowl from the base. The tab protrudes from the bowl base or cavity wall and is receivable within a recessed portion, whereby the tab and the recessed portion cooperatively inhibit rotation of the bowl base within the cavity.

### FIELD OF THE INVENTION

The present disclosure relates generally to stand mixers, or more specifically, to the bowl coupling assembly of a stand mixer.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. Such utensils are often used to mix various ingredients together in a bowl. Various bowl coupling assemblies, such as bowl supports and anchors, have been developed to couple the bowl to the stand mixer to inhibit or prevent movement of the bowl during mixing. While such bowl coupling assemblies work well, further improvements are needed.

Accordingly, a stand mixer having a bowl coupling assembly would be desirable. More specifically, a bowl coupling assembly that is capable of inhibiting rotation of the bowl when a utensil is being used to mix ingredients in the bowl would be particularly beneficial.

### BRIEF DESCRIPTION OF THE INVENTION

Aspects and advantages of the invention will be set forth in part in the following description, or may be apparent from the description, or may be learned through practice of the invention.

In one example aspect, a stand mixer is provided. The stand mixer includes a base defining a bowl cavity surrounded by a bowl cavity wall, a support column coupled to the base and extending upwardly from the base, a head coupled to an upper end of the support column and extending from the support column above the base, and a bowl configured to be removable coupled to the base. The bowl includes a bowl reservoir for holding mixing ingredients and a bowl base defining a perimeter. The bowl base is configured to be inserted within the bowl cavity. Additionally, the stand mixer includes a bowl coupling assembly for removably coupling the bowl to the base of the stand mixer. The bowl coupling assembly includes a tab including a sloped feature upon which the bowl is tiltable to remove the bowl from the base. The tab protrudes from the bowl base or the bowl cavity wall and is configured to be received within and bounded by a recessed portion, whereby the tab and the recessed portion cooperatively inhibit rotation of the bowl base within the bowl cavity.

In another example aspect, a bowl for a stand mixer is provided. The stand mixer includes a base defining a bowl cavity surrounded by a bowl cavity wall, a support column coupled to the base and extending upwardly from the base, and a head coupled to an upper end of the support column and extending from the support column above the base. The bowl includes a bowl reservoir for holding mixing ingredients and a bowl base defining a perimeter. The bowl base is configured to be inserted within the bowl cavity. Additionally, the bowl includes a bowl coupling assembly for removably coupling the bowl to the base of the stand mixer. The bowl coupling assembly includes a tab including a sloped feature upon which the bowl is tiltable to remove the bowl from the base. The tab protrudes from the perimeter of the bowl base and is configured to be received within and bounded by a recessed portion defined within the bowl cavity wall, whereby the tab and the recessed portion cooperatively inhibit rotation of the bowl base within the bowl cavity.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an example embodiment of a stand mixer of the present disclosure.

FIG. 2 is a perspective view of an example embodiment of a base of the example stand mixer of FIG. 1.

FIG. 3 is a close-up perspective cross-sectional view of the example base of FIG. 2 taken about Line 3-3 in FIG. 2.

FIG. 4 is a perspective view of an example embodiment of a bowl of the example stand mixer of FIG. 1.

FIG. 5 is a top view of a portion of the example base of FIG. 2 and a portion of the example bowl of FIG. 4.

FIG. 6 is a close-up perspective cross-sectional view of the example bowl of FIG. 4 and the example base of FIG. 2.

FIG. 7 is a close-up perspective cross-sectional view of the example bowl of FIG. 4 and the example base of FIG. 2.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

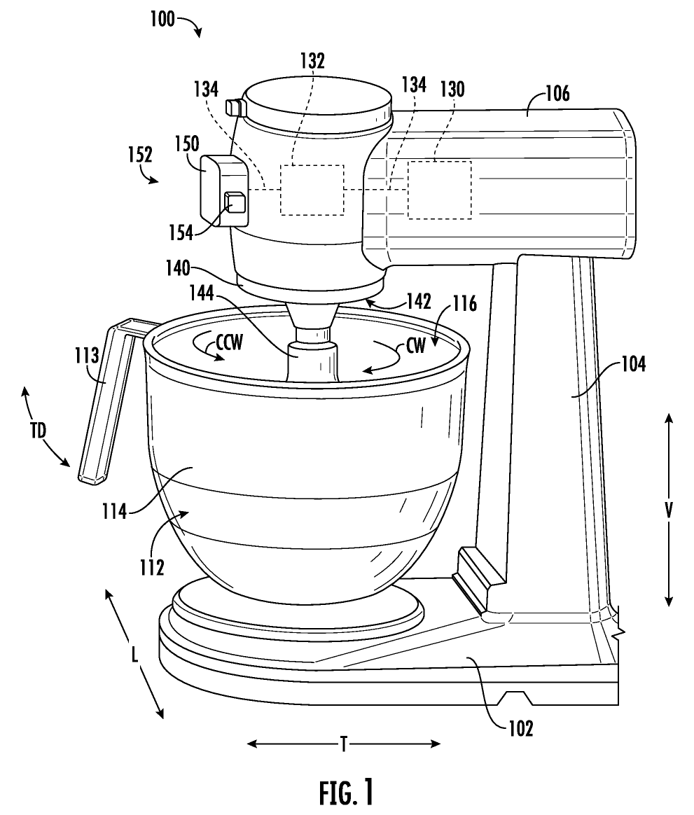

FIG. 1 provides a perspective view of a stand mixer 100 according to an example embodiment of the present subject matter. It will be understood that stand mixer 100 is provided by way of example only and that the present subject matter may be used in or with any suitable stand mixer in alternative example embodiments. Moreover, with reference to FIG. 1, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

Stand mixer 100 may include a mixer base 102 and a support post or column 104. Support column 104 may support a mixer head 106, which is positioned atop column 104. Mixer head 106 may house a motor 130, a gearbox 132, and/or a drivetrain apparatus 134 of stand mixer 100. For example, as shown in FIG. 1, head 106 may be mounted to column 104, which is mounted to mixer base 102. Thus, column 104 may extend between and connect mixer base 102 and head 106, e.g., along the vertical direction V. Head 106 may extend outwardly above the mixer base 102, e.g., in the transverse direction T.

Furthermore, head 106 includes a mixing attachment support 140. Mixing attachment support 140 is located on a lower portion or underside 142 of head 106 and forward of support column 104 along transverse direction T. A rotating mixing attachment 144 is removably coupled to the mixing attachment support 140. The drivetrain apparatus 134 connects the motor 130 with the gearbox 132 and the mixing attachment support 140 such that the motor 130 may drive rotation of the mixing attachment 144 when the mixing attachment 144 is coupled to the mixing attachment support 140. The gearbox 132 may allow user selection of different rotating speeds for the mixing attachment 144. The stand mixer 100 may include one or more controls for operations such as selectively powering the motor 130, choosing the speed of rotation for the mixing attachment 144, and other features. In certain embodiments, the mixing attachment support 140 may accept more than one type of mixing attachment 144. Various types of mixing attachments may be used including e.g., whisks, paddles, dough hooks, beaters, and others for purposes of mixing ingredients within a bowl or other container supported by the mixer base 102. During use, rotation of the mixing attachment 144 may be driven in a circular or planetary manner in either a rotational clockwise direction CW and/or a rotational counterclockwise direction CCW directionally opposite clockwise direction CW. Spinning in a planetary manner, as used herein, includes spinning both in a circular manner and rotating about an axis that moves in a circular manner. In some embodiments, the motor 130 may be disposed within mixer base 102, including within the column 104.

Example operation of an exemplary embodiment of the stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on a motor to begin the process of mixing, kneading, beating, etc. The motor rotates an attachment attached to stand mixer 100 to complete each of these processes. The processes may be conducted with a respective attachment such as a mixer blade for mixing, a dough hook for kneading, and a balloon whisk for beating.

Furthermore, in some embodiments, head 106 includes an auxiliary attachment support 150 located on a forward portion or frontside 152 of head 106 in the transverse direction T and forward of support column 104 in the transverse direction T. An auxiliary attachment assembly (not shown), such as a pasta attachment, may be removably coupled to the auxiliary attachment support 150. For example, a removable pin 154 may couple the auxiliary attachment assembly (not shown) to the auxiliary attachment support 150. The drivetrain apparatus 134 connects the motor 130 with the gearbox 132 and the auxiliary attachment support 150 such that the motor 130 may drive rotation of various components of the auxiliary attachment assembly (not shown) when the auxiliary attachment assembly (not shown) is coupled to the auxiliary attachment support 150. In certain embodiments, the auxiliary attachment support 150 may accept more than one type of auxiliary attachment assembly.

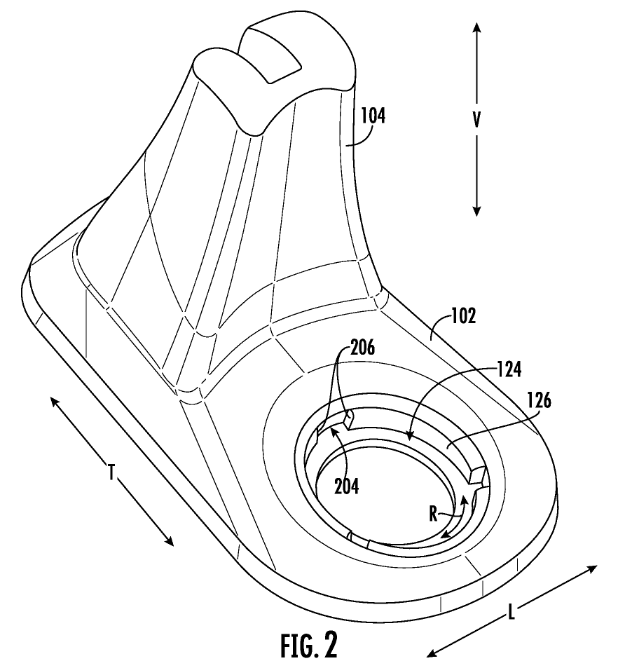

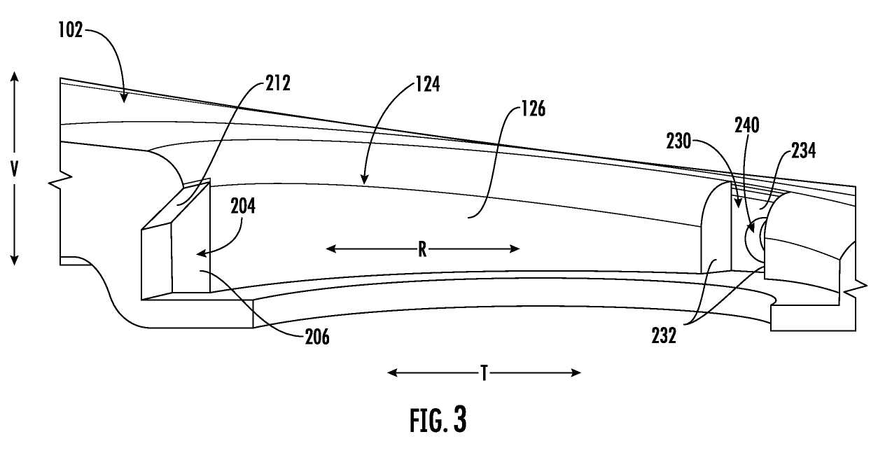

Referring now to FIGS. 1 through 7, mixer base 102, bowl 112, and bowl coupling assembly 200 that may be used with stand mixer 100 for removably coupling bowl 112 to mixer base 102 of stand mixer 100 will be described according to example embodiments of the present subject matter.

According to example embodiments, a bowl cavity 124 defined within the mixer base 102 and surrounded by a bowl cavity wall 126. As will be described below, bowl cavity 124 may receive bowl 112 therein. In the example embodiment, bowl cavity wall 126 may be cylindrically shaped. However, it should be appreciated that, in other embodiments, bowl cavity wall 126 may be any other suitable shape.

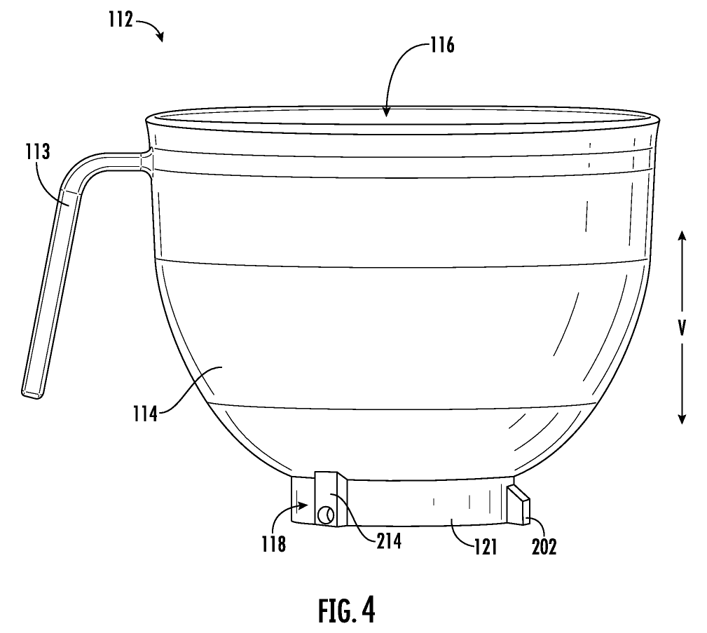

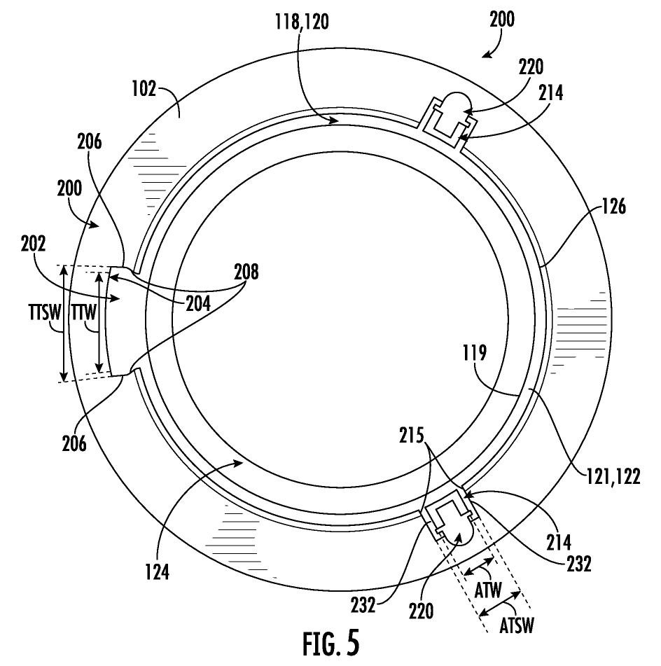

According to example embodiments, bowl 112 may include bowl reservoir 114 defining interior portion 116 for receiving and holding mixing ingredients during mixing. The mixing attachment 144 may extend into interior portion 116 of bowl reservoir 114 for mixing or otherwise manipulating mixing ingredients within interior portion 116 of bowl reservoir 114, e.g., when the bowl is coupled to the mixer base 102, as will be described further below. Additionally, as best illustrated in FIG. 4, bowl 112 may include bowl base 118. Bowl reservoir 114 may be supported on bowl base 118. In this regard, bowl base 118 may be positioned below bowl reservoir 114 and attached to bowl reservoir 114. Bowl base 118 may also include a bowl base wall 120 including an inner wall surface 119 (FIGS. 5-7) and an outer wall surface 121 (FIGS. 4-6). In the example embodiment, bowl base 118 may be cylindrically shaped and, as such, bowl base wall 120 may be circular and, thus, outer wall surface 121 may define circular perimeter 122. However, it should be appreciated that, in other embodiments, bowl base 118 may be any other suitable shape.

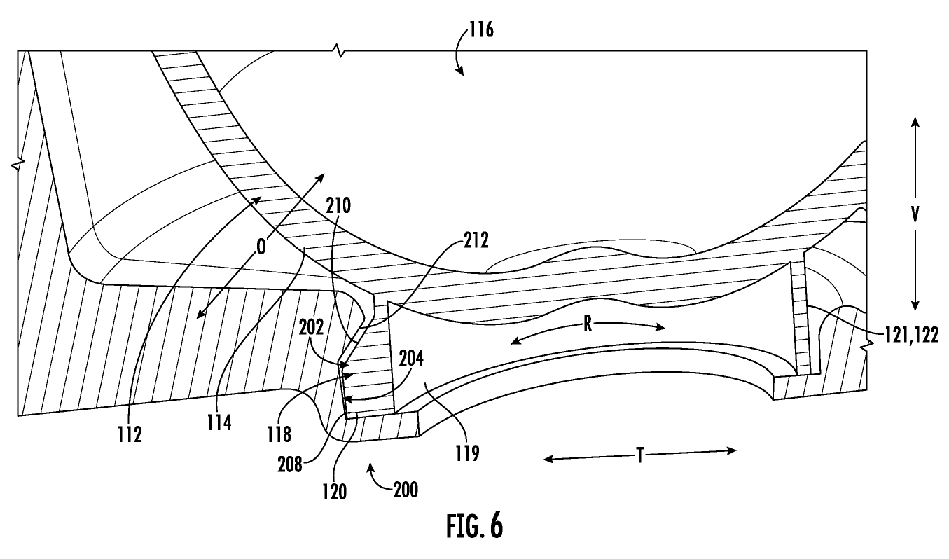

According to example embodiments, bowl 112 may be removably coupled to mixer base 102. As such, bowl 112 may include handle 113 for moving manipulating bowl 112 to couple bowl 112 to mixer base 102 or decouple bowl 112 from mixer base 102. When coupling bowl 112 to mixer base 102, bowl base 118 may be partially inserted within bowl cavity 124, which may be substantially similar in diameter to cylindrically shaped bowl base 118, then handle 113 may be used to pivot or tilt bowl 112 downward in tilt direction TD (FIG. 1) so that bowl base 118 is completely or fully inserted within bowl cavity 124. As best illustrated in FIGS. 5 and 6, when bowl base 118 is completely inserted within bowl cavity 124, bowl cavity wall 126 surrounds bowl base wall 120. Additionally, when decoupling bowl 112 from mixer base 102, handle 113 may be used to pivot or tilt bowl 112 upward in tilt direction TD so that bowl base 118 is removed from bowl cavity 124.

According to example embodiments, bowl coupling assembly 200 may include a tilt tab 202. Tilt tab 202 may protrude from outer wall surface 121 of bowl base wall 120. A tilt tab slot or recessed portion 204 may be defined within bowl cavity wall 126 and extend beyond the diameter of bowl cavity wall 126. As best illustrated in FIGS. 5 and 6, tilt tab 202 may be inserted or received within tilt tab slot 204, for example, in vertical direction V, and bounded by tilt tab slot 204 in rotational direction R. For example, tilt tab slot 204 may be surrounded by a pair of laterally opposed or spaced apart slot walls 206 and tilt tab 202 may include a pair of laterally opposed or spaced apart tab walls 208 positioned between slot walls 206 when tilt tab 202 is inserted within tilt tab slot 204. Tab walls 208 may be spaced apart by a tilt tab width TTW substantially similar to, but lesser than, a tilt tab slot width TTSW by which slot walls 206 are spaced apart from each other. For example, tilt tab width TTW may be lesser than tilt tab slot width TTSW by a ratio of 9:10. As such, when tilt tab 202 is inserted within tilt tab slot 204, the tilt tab 202 may be constrained between the walls of the slot 204, such that the tab and the recessed portion cooperatively inhibit rotation of the bowl base within the bowl cavity along the rotational direction R, e.g., slot walls 206 may engage the tilt tab 202 along the rotational direction R and thereby prevent tilt tab 202 and, thus, bowl base 118, from being rotated in within bowl cavity 124.

Furthermore, tilt tab 202 may include a sloped feature upon which bowl 112 is tiltable to remove or decouple bowl 112 from mixer base 102. For example, as best illustrated in FIG. 6, sloped feature may correspond to a tab sloped wall 210 which may extend in oblique direction O and may be positioned above tab walls 208. Additionally, a slot sloped wall 212 may be positioned within tilt tab slot 204, slot sloped wall 212 also extending in oblique direction O and positioned above slot walls 206. When tilt tab 202 is inserted within tilt tab slot 204, slot sloped wall 212 may be positioned above tilt sloped wall 210. Bowl 112 may be decoupled from mixer base 102 by tilting bowl 112 upon tilt sloped wall 210 of tilt tab slot 204, which may contact slot sloped wall 212. Slot sloped wall 212 may thus act as a fulcrum or pivoting point that tilt sloped wall 210 contacts as bowl 112 is tilted upon tilt sloped wall 210.

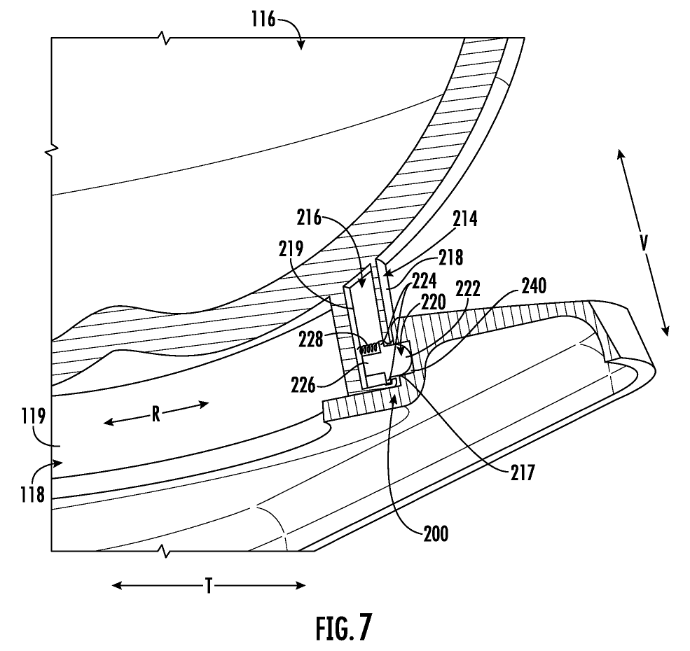

According to example embodiments, bowl coupling assembly 200 may also include an actuator, such as a linear plunger 220. In some embodiments, linear plunger 220 may include a plunger head 222, a plunger collar 224, and a plunger shaft 226. As best illustrated in FIG. 7, plunger collar 224 and plunger head 222 may be slidably mounted on plunger shaft 226. Additionally, plunger collar 224 and plunger head 222 may slide in tandem along plunger shaft 226. Furthermore, linear plunger 220 may be moveable between an extended position (FIG. 7) and a retracted position (not shown). As will be described below, plunger 220 may be moved to extended position to couple bowl 112 to mixer base 102.

According to example embodiments, linear plunger 220 may be coupled or attached to bowl base 118 and protrude outwardly from bowl base 118 and extend beyond the diameter of bowl cavity wall 126 when in the extended position. For example, as best illustrated in FIGS. 5 and 7, bowl coupling assembly 200 may include an actuator tab 214 that protrudes from outer wall surface 121 of bowl base wall 120. As shown in FIG. 7, plunger shaft 226 and plunger collar 224 of linear plunger 220 may be positioned within an actuator tab interior portion 216, and plunger head 222 may protrude from actuator tab 214 by extending through and out of an actuator hole or cavity 217 defined through an actuator tab wall 218 of actuator tab 214 when linear plunger 220 is in the extended position. Furthermore, plunger collar 224 may extend beyond the dimensions (e.g., diameter) defined by actuator cavity 217 and contact outer actuator tab wall surface 218 to retain linear plunger 220 at least partially within actuator tab interior portion 216. Moreover, bowl coupling assembly 200 may include a biasing element, such as a spring 228, for biasing linear plunger 220 in the extended position. As illustrated in FIG. 7, spring 228 may be positioned within actuator tab interior portion 216 between plunger collar 224 and inner actuator tab wall surface 219 to bias plunger collar 224 against outer actuator tab wall surface 218 and, thus, linear plunger 220 in the extended position. As such, plunger head 222 may protrude from actuator tab 214 by extending through and out of an actuator hole or cavity 217 defined through an actuator tab wall 218 of actuator tab 214.

According to example embodiments, an actuator tab slot or recessed portion 230 may be defined within bowl cavity wall 126 and extend beyond the diameter of bowl cavity wall 126. Actuator tab slot 230 may be a different opening defined within bowl cavity wall 126 than tilt tab slot 204. As best illustrated in FIG. 5, actuator tab 214 may be inserted or received within actuator tab slot 230, for example, in vertical direction V, and bounded by actuator tab slot 230 in rotational direction R. For example, actuator tab slot 230 may include a pair of laterally opposed or spaced apart slot walls 232 and actuator tab 214 may include a pair of laterally opposed or spaced apart tab walls 215 positioned between slot walls 232 when actuator tab 214 is inserted within actuator tab slot 230. Tab walls 215 may be spaced apart by an actuator tab width ATW substantially similar to, but lesser than, an actuator tab slot width ATSW by which slot walls 232 are spaced apart from each other. For example, actuator tab width ATW may be lesser than actuator tab slot width ATSW by a ratio of 9:10. As such, when actuator tab 214 is inserted within actuator tab slot 230, the actuator and the actuator slot thereby cooperatively inhibit rotation of the bowl base, e.g., the slot walls 215 prevent actuator tab 214 and, thus, bowl base 118, from being rotated in within bowl cavity 124.

According to example embodiments, tilt tab 202 and actuator tab 214 are spaced apart from each other along perimeter 122 defined by outer wall surface 121 of bowl base 118. Since linear plunger 220 is positioned within actuator tab 214, tilt tab 202 and linear plunger 220 are also spaced apart from each other along perimeter 122 defined by outer wall surface 121 of bowl base 118. Likewise, tilt tab slot 204 and actuator tab slot 230 are spaced apart from each other along bowl cavity wall 126 by the same or substantially similar amount that tilt tab 202 and actuator tab 214 are spaced apart from each other along perimeter 122 defined by outer wall surface 121 of bowl base 118. As such, tilt tab 202 may be received within tilt tab slot 204 simultaneously with or while actuator tab 214 is received within actuator tab slot 230 to couple bowl 112 to mixer base 102 and for inhibiting rotation of bowl base 118 within bowl cavity 124.

According to example embodiments, an actuator slot 240 is defined within an inner wall 234 of actuator tab slot 230 and, thus, positioned within actuator tab slot 230. As such, when tilt tab 202 is received within tilt tab slot 204 simultaneously with or while actuator tab 214 is received within actuator tab slot 230 to couple bowl 112 to mixer base 102, plunger head 222 of linear plunger 220 may be aligned with actuator slot 240. In this respect, when spring 228 biases linear plunger 220 in the extended position, plunger head 222 is received within and bounded by actuator slot 240 simultaneously or while tilt tab 202 is received within tilt tab slot 204 and while actuator tab 214 is received within actuator tab slot 230 to couple bowl 112 to mixer base 102 and for inhibiting rotation of bowl base 118 within bowl cavity 124.

According to example embodiments, bowl 112 may be removed or decoupled from mixer base 102 by using handle 113 to lift to tilt bowl 112 upward in tilt direction TD. When bowl 112 is tilted upward, slot sloped wall 212 of tilt tab slot 204 may act as a fulcrum or pivoting point that tilt sloped wall 210 of tilt tab 202 contacts as bowl 112 is tilted upon tilt sloped wall 210. Additionally, when bowl 112 is tilted upward, a pressure is applied to plunger head 222 of linear plunger 220 in the opposite direction of the biasing pressure being applied by spring 228 such that plunger head 222 is pushed out of and removed from actuator slot 240. Once plunger head 222 is removed from actuator slot 240, actuator tab 214 may be removed from actuator tab slot 230 and tilt tab 202 may be removed from tilt tab slot 204 as bowl 112 continues to be tilted upward and, thus, decoupled from mixer base 102.

For purposes of illustration, all protrusions of bowl coupling assembly 200 (e.g., tilt tab 202, actuator tab 214, linear plunger 220) were described as part of bowl 112 of stand mixer 100. Additionally, all recesses of bowl coupling assembly 200 (e.g., tilt tab slot 204, actuator tab slot 230, actuator slot 240) were described as part of mixer base 102. However, it should be appreciated that all protrusions of bowl coupling assembly 200 may be included as part of mixer base 102 and all recesses of bowl coupling assembly 200 may be included as part of bowl 112. Furthermore, it should be appreciated that some protrusions of bowl coupling assembly 200 may be included as part of bowl 112 while some protrusions of bowl coupling assembly 200 may be included as part of mixer base 102. Likewise, it should be appreciated that some recesses of bowl coupling assembly may be included as part of bowl 112 while some recesses of bowl coupling assembly 200 may be included as part of mixer base 102.

As explained herein, aspects of the present subject matter are generally directed to a bowl coupling assembly of a stand mixer. The bowl coupling assembly may include a tilt tab and an actuator that is received within an actuator slot for inhibiting rotation of the bowl within the bowl cavity of the mixer base. In this respect, mixing tools of the stand mixer may be used multi-directionally (e.g., in the clockwise and counterclockwise directions) without causing the bowl to rotate within the bowl cavity. Additionally, the tilt tab may include a sloped feature upon which the bowl may be tilted to remove or decouple the bowl from the mixer base of the stand mixer without requiring the bowl to be rotated for decoupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer, comprising:
a base defining a bowl cavity surrounded by a bowl cavity wall;
a support column coupled to the base and extending upwardly from the base;
a head coupled to an upper end of the support column and extending from the support column above the base;
a bowl configured to be removably coupled to the base, the bowl comprising:
a bowl reservoir for holding mixing ingredients; and
a bowl base defining a perimeter, the bowl base configured to be inserted within the bowl cavity; and
a bowl coupling assembly for removably coupling the bowl to the base of the stand mixer, the bowl coupling assembly comprising:
a tab including a sloped feature upon which the bowl is tiltable to remove the bowl from the base, the tab protruding from the bowl base or the bowl cavity wall and configured to be received within and bounded by a recessed portion, whereby the tab and the recessed portion cooperatively inhibit rotation of the bowl base within the bowl cavity.

2. The stand mixer of claim 1, wherein:
the recessed portion is defined within the bowl cavity wall; and
the tab protrudes from the perimeter of the bowl base and is configured to be received within and bounded by the recessed portion whereby the tab and the recessed portion cooperatively inhibit rotation of the bowl base within the bowl cavity.

3. The stand mixer of claim 1, the bowl coupling assembly further comprising:
an actuator moveable between an extended and retracted position, the actuator protruding from the bowl base or the bowl cavity wall when in the extended position,
wherein:
an actuator slot is defined within the bowl base or the bowl cavity wall; and
the actuator is configured to be received within and bounded by the actuator slot when the actuator is in the extended position whereby the actuator and the actuator slot cooperatively inhibit rotation of the bowl base within the bowl cavity.

4. The stand mixer of claim 3, the bowl coupling assembly further comprising:
a biasing element coupled to the actuator, whereby the biasing element biases the actuator in the extended position.

5. The stand mixer of claim 3, wherein:
the tab and the actuator are spaced apart from each other along the perimeter of the bowl base or along the bowl cavity wall and positioned to be simultaneously received within the recessed portion and the actuator slot respectively, whereby engagement of the tab with the recessed portion and engagement of the actuator with the actuator slot inhibits rotation of the bowl base within the bowl cavity.

6. The stand mixer of claim 3, wherein the sloped feature of the tab comprises:
a tab sloped wall extending into the recessed portion in an oblique direction relative to the perimeter of the bowl base,
wherein, when the bowl is tilted upon the tab sloped wall, the actuator is removed from the actuator slot.

7. The stand mixer of claim 6, wherein:
the recessed portion includes a recessed portion sloped wall positioned above the tab sloped wall when the tab is received within the recessed portion.

8. The stand mixer of claim 3, wherein the tab corresponds to a tilt tab, the bowl coupling assembly further comprising:
an actuator tab protruding from the bowl base or the bowl cavity wall, the actuator protruding from the actuator tab when the actuator is in the extended position.

9. The stand mixer of claim 8, wherein:
the recessed portion corresponds to a first recessed portion;
a second recessed portion is defined within the bowl base or the bowl cavity wall and different from the first recessed portion; and
the actuator tab is configured to be received within and bounded by the second recessed portion.

10. The stand mixer of claim 9, wherein:
the tilt tab, the actuator tab, and the actuator are simultaneously received within the first recessed portion, the second recessed portion, and the actuator slot respectively.

11. The stand mixer of claim 9, wherein:
the actuator slot is positioned within the second recessed portion.

12. A bowl for a stand mixer, the stand mixer including a base defining a bowl cavity surrounded by a bowl cavity wall, a support column coupled to the base and extending upwardly from the base, a head coupled to an upper end of the support column and extending from the support column above the base, the bowl comprising:
a bowl reservoir for holding mixing ingredients;
a bowl base defining a perimeter, the bowl base configured to be inserted within the bowl cavity; and
a bowl coupling assembly for removably coupling the bowl to the base of the stand mixer, the bowl coupling assembly comprising:
a tab including a sloped feature upon which the bowl is tiltable to remove the bowl from the base, the tab protruding from the perimeter of the bowl base and configured to be received within and bounded by a recessed portion defined within the bowl cavity wall, whereby the tab and the recessed portion cooperatively inhibit rotation of the bowl base within the bowl cavity.

13. The bowl of claim 12, the bowl coupling assembly further comprising:
an actuator moveable between an extended and retracted position, the actuator protruding from the bowl base when in the extended position,
wherein:
an actuator slot is defined within the bowl cavity wall; and
the actuator is configured to be received within and bounded by the actuator slot when the actuator is in the extended position whereby the actuator and the actuator slot cooperatively inhibit rotation of the bowl base within the bowl cavity.

14. The bowl of claim 13, the bowl coupling assembly further comprising:
a biasing element coupled to the actuator, whereby the biasing element biases the actuator in the extended position.

15. The bowl of claim 13, wherein:
the tab and the actuator are spaced apart from each other along the perimeter of the bowl base or along the bowl cavity wall and positioned to be simultaneously received within the recessed portion and the actuator slot respectively, whereby engagement of the tab with the recessed portion and engagement of the actuator with the actuator slot inhibits rotation of the bowl base within the bowl cavity.

16. The bowl of claim 13, wherein the sloped feature of the tab comprises:
a tab sloped wall extending into the recessed portion in an oblique direction relative to the perimeter of the bowl base,
wherein, when the bowl is tilted upon the tab sloped wall, the actuator is removed from the actuator slot.

17. The bowl of claim 16, wherein:
the recessed portion includes a recessed portion sloped wall positioned above the tab sloped wall when the tab is received within the recessed portion.

18. The bowl of claim 13, wherein the tab corresponds to a tilt tab, the bowl coupling assembly further comprising:
an actuator tab protruding from the bowl base, the actuator protruding from the actuator tab when the actuator is in the extended position.

19. The bowl of claim 18, wherein:
the recessed portion corresponds to a first recessed portion;
a second recessed portion is defined within the bowl cavity wall and different from the first recessed portion; and
the actuator tab is configured to be received within and bounded by the second recessed portion.

20. The bowl of claim 19, wherein:
the tilt tab, the actuator tab, and the actuator are simultaneously received within the first recessed portion, the second recessed portion, and the actuator slot respectively.
